(19) United States
(12) Patent Application Publication
(10) Pub. No.: US 2025/0341446 A1
(43) Pub. Date: Nov. 6, 2025

(54) Diagnosis Device and Diagnosis Method for Internal Combustion Engine

(71) Applicant: Hitachi, Ltd., Chiyoda-ku, Tokyo (JP)

(72) Inventors: Shogo NAMBA, Tokyo (JP); Atsushi SHIMADA, Tokyo (JP); Yoshihiro SUKEGAWA, Tokyo (JP)

(21) Appl. No.: 18/869,904

(22) PCT Filed: May 24, 2023
(86) PCT No.: PCT/JP2023/019358

§ 371 Date: Nov. 27, 2024

(30) Foreign Application Priority Data
Aug. 10, 2022 (JP) 2022-127910

(51) Int. Cl. G01M 15/05; G01M 15/11

(52) U.S. Cl. CPC G01M 15/05; G01M 15/11

(57) ABSTRACT

Provided is a diagnosis device for an internal combustion engine that, even where an existing internal combustion engine in which an in-cylinder pressure sensor is not installed or an internal combustion engine in which an in-cylinder pressure sensor is broken down is put in a transient state, can estimate a combustion state of the internal combustion engine. The diagnosis device for an internal combustion engine that diagnoses an internal combustion engine causing an electric motor to generate electric power includes: a current information acquisition unit that acquires current information from the electric motor; a fuel injection information acquisition unit that acquires fuel injection information from a control unit controlling the internal combustion engine; and a combustion abnormality detection unit that estimates a combustion state of the internal combustion engine on the basis of the current information and the fuel injection information.

### TECHNICAL FIELD

The present invention relates to a diagnosis device and a diagnosis method for an internal combustion engine that estimate a combustion state of the internal combustion engine from current information of an electric motor.

### BACKGROUND ART

For example, for an automotive internal combustion engine, a control device for the internal combustion engine that controls the internal combustion engine estimates a combustion state based on information from sensors attached to units and a control unit determines a control parameter of an actuator for an accelerator opening command from an operator in order to appropriately maintain the combustion state of the internal combustion engine. In a stationary internal combustion engine for power generation, the internal combustion engine and an electric motor for power generation are in communication with each other, and rotational torque generated by the internal combustion engine is converted into electric power by the electric motor for power generation and then supplied to an electric power system. In both the internal combustion engines, damage and abnormal vibrations can be avoided by appropriately maintaining the combustion states of the internal combustion engines, and particularly in the stationary internal combustion engine that is directly connected to the electric power system, it is necessary to monitor the combustion state in detail and perform control to minimize a variation in power supply to the electric power system.

As methods of monitoring the combustion state, in general, monitoring methods using a misfire sensor as detection means for a case where a misfire occurs, a knocking sensor as detection means for a case where abnormal combustion occurs, an in-cylinder pressure sensor that measures in-cylinder pressure in each cylinder of the internal combustion engine have been proposed. Particularly, in the monitoring method using the in-cylinder pressure sensor, since it is possible to measure in-cylinder pressure in each cylinder of the internal combustion engine, abnormal combustion can be detected, and in a case where a mechanical calculation formula for the internal combustion engine is used, it is also possible to calculate torque of the internal combustion engine from the in-cylinder pressure. Therefore, particularly, in the stationary internal combustion engine that is directly connected to the electric power system, it is essential to install it as control to minimize a variation in power supply to the electric power system.

As a technique for suppressing abnormal combustion, for example, Patent Literature 1 exists. Abstract of Patent Literature 1 describes, as a solution to “successfully suppress the occurrence of a backfire in an internal combustion engine that uses hydrogen as fuel”, “a technique for detecting whether a pre-ignition backfire has occurred in each cylinder based on the in-cylinder pressure and crank angle of each cylinder, performing control to increase the combustion rate for each cylinder where the occurrence of pre-ignition has been detected, and performing control to lower the temperature in each cylinder where the occurrence of a back fire has been detected”.

In addition, claim 1 of Patent Literature 1 describes that, “in a control device for an internal combustion engine in which hydrogen fuel is supplied to each cylinder from an intake path upstream of an intake valve of each cylinder, crank angle detection means for detecting a crank angle of the internal combustion engine, an in-cylinder pressure sensor provided for each cylinder of the internal combustion engine, and abnormal combustion detection means for performing an abnormal combustion detection process on each cylinder to detect whether pre-ignition has occurred in each cylinder and whether a backfire has occurred in each cylinder, based on in-cylinder pressure detected by each in-cylinder pressure sensor and the crank angle detected by the crank angle detection means are provided”.

As a technique for detecting a misfire by using output torque, for example, Patent Literature 2 exists. Abstract of Patent Literature 2 describes that, “regarding misfire detection that is started when a GO signal is generated in the second cylinder of an engine, in a case where a misfire does not occur in any cylinder, a current output torque command value gtrq and a previous output torque command value gtrgo do not significantly vary, and thus it is determined that a misfire has not occurred in the previous cylinder, that is, the fourth cylinder. On the other hand, in a case where a misfire occurs in the fourth cylinder, gtrq falls significantly compared with gtrqo and thus it is determined that there is a possibility that a misfire may occur in the fourth cylinder”.

Patent Literature 2 describes that, “to explain vibration damping control in more detail, the M/G ECU 17 executes a vibration damping control program illustrated in FIG. 2 in interrupt processing every time the crankshaft 1a rotates by a predetermined minute angle (for example, 0.1°). When this program is started, the M/G ECU 17 takes in a target rotation speed New of the engine 1 and an actual rotation speed Ne of the engine 1 in step (hereinafter referred to as S) 101, calculates the difference ANe (=Ne—Ne*) between the rotation speeds in the subsequent S102, calculates an output torque command value for first M/G3 such that the difference ANe becomes zero in the subsequent S103” (paragraph 0028), and “it is possible to accurately detect a misfire in a multi-cylinder internal combustion engine in a hybrid vehicle executing a vibration damping control” (paragraph 11).

### CITATION LIST

### Patent Literature

Patent Literature 1: Japanese Unexamined Patent Application Publication No. 2016-130473
Patent Literature 2: Japanese Unexamined Patent Application Publication No. 2000-240501

### SUMMARY OF INVENTION

### Technical Problem

In Patent Literature 1, by using each in-cylinder pressure sensor and a crank angle sensor, it is possible to detect abnormal combustion in each cylinder.

However, the in-cylinder pressure sensors described in Patent Literature 1 are very expensive, and thus installing the in-cylinder pressure sensors for the respective cylinders results in a correspondingly expensive system. In addition, when the sensors are installed in an existing system, it is necessary that, after disassembly of the internal combustion engine, holes be formed in an engine head portion and the in-cylinder pressure sensors be inserted into the holes. Therefore, there is a problem in that it is difficult to install the system described in Patent Literature 1 in an internal combustion engine that is not substantially provided with an in-cylinder pressure sensor.

In addition, in Patent Literature 2, a misfire is detected based on output torque while control is performed to suppress vibrations.

However, there is a problem in that the difference between a target engine speed and an actual engine speed is large in a transient state, and when a misfire is detected using a vibration damping system that performs control to suppress vibrations, the misfire is likely to be erroneously detected.

Therefore, an object of the present invention is to provide a diagnosis device and a diagnosis method for an internal combustion engine that are capable of estimating a combustion state of the internal combustion engine even in a case where an existing internal combustion engine in which an in-cylinder pressure sensor is not installed or an internal combustion engine in which an in-cylinder pressure sensor has failed is in a transient state.

### Solution to Problem

To solve the above-described problems, a diagnosis device for an internal combustion engine according to the present invention is, for example, a diagnosis device for an internal combustion engine that diagnoses the internal combustion engine that causes an electric motor to generate electric power, and the diagnosis device includes a current information acquisition unit that acquires current information from the electric motor; a fuel injection information acquisition unit that acquires fuel injection information from a control unit that controls the internal combustion engine; and a combustion abnormality detection unit that estimates a combustion state of the internal combustion engine based on the current information and the fuel injection information.

In addition, a diagnosis method for an internal combustion engine according to the present invention is, for example, a diagnosis method for an internal combustion engine that diagnoses the internal combustion engine that causes an electric motor to generate electric power, and the diagnosis method includes a current information acquisition step of acquiring current information from the electric motor; a fuel injection information acquisition step of acquiring fuel injection information from a control unit that controls the internal combustion engine; and a combustion abnormality detection step of estimating a combustion state of the internal combustion engine based on the current information and the fuel injection information.

### Advantageous Effects of Invention

According to the present invention, it is possible to provide a diagnosis device and a diagnosis method for an internal combustion engine that are capable of estimating a combustion state of an internal combustion engine even in a case where an existing internal combustion engine in which an in-cylinder pressure sensor is not installed or an internal combustion engine in which an in-cylinder pressure sensor fails is in a transient state.

### BRIEF DESCRIPTION OF DRAWINGS

FIG. 1 is a schematic diagram of an engine system.

FIG. 2 is a functional block diagram of a diagnosis device for an internal combustion engine according to a first embodiment.

FIG. 3 is a diagram for explaining a method of breaking down current information into combustion sections of respective cylinders.

FIG. 4 is a diagram illustrating an example of a waveform of a torque component.

FIG. 5 are diagrams for explaining a relationship between fuel injection information and the amount of fuel injected.

FIG. 6 is a diagram illustrating an example of a map of the amount of fuel injected according to the first embodiment.

FIG. 7 is a flowchart of a learning process according to the first embodiment.

FIG. 8 is a diagram illustrating plotted torque peaks with respect to amounts of fuel injected according to the first embodiment.

FIG. 9 is a flowchart of an abnormality detection process according to the first embodiment.

FIG. 10 is a functional block diagram of a diagnosis device for an internal combustion engine according to a second embodiment.

FIG. 11 is a flowchart of a learning process according to the second embodiment.

FIG. 12 is a diagram illustrating plotted torque peaks with respect to a fuel injection pulse width and fuel injection pressure according to the second embodiment.

FIG. 13 is a flowchart of an abnormality detection process according to the second embodiment.

### DESCRIPTION OF EMBODIMENTS

Hereinafter, a diagnosis device 1 for an internal combustion engine according to each of embodiments of the present invention will be described in detail with reference to the drawings. The present invention is not limited to the embodiments described below. In each of the embodiments, the internal combustion engine is a stationary four-cylinder engine, and an electric motor is a synchronous motor. However, the diagnosis device for the internal combustion engine of the present invention is not limited thereto. As long as the engine is an internal combustion engine, the internal combustion engine can be applied regardless of the number of cylinders and cylinder arrangement, such as an in-line type or a V type, and as long as the motor is an electric motor, the electric motor can be applied regardless of the type of motor, such as an induction motor or a permanent magnet motor. In each drawing used for the following description, each common device and common equipment are given the same reference signs. Description of each device, equipment, and operation that have already been described may be omitted.

### First Embodiment

### [Engine System]

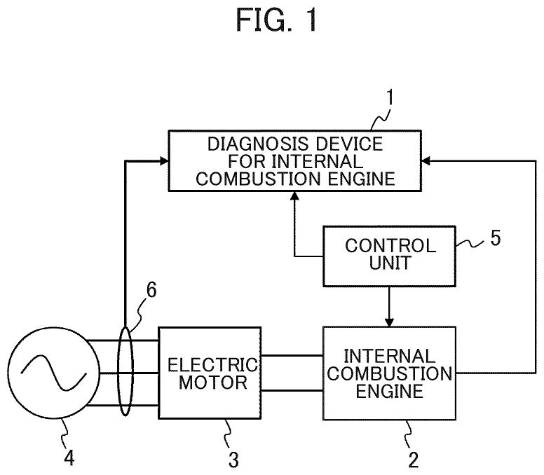

FIG. 1 is a schematic diagram of an engine system. FIG. 1 is a schematic diagram of the engine system including a diagnosis device 1 for an internal combustion engine, an internal combustion engine 2, an electric motor 3, a power source 4, a control unit 5, and a current information detection unit 6.

The diagnosis device 1 for the internal combustion engine diagnoses a combustion state of the internal combustion engine 2 based on signals from the control unit 5 and the current information detection unit 6.

The internal combustion engine 2 according to the present embodiment is a four-cylinder engine including four cylinders and generates desired combustion torque based on a control command of the control unit 5.

The electric motor 3 is a three-phase alternating-current synchronous motor mechanically connected to the internal combustion engine 2. The electric motor 3 rotates at the same rotation speed as the rotation speed of the internal combustion engine and generates regenerative electric power by electromagnetic induction.

In the power source 4, the regenerative electric power generated by the electric motor 3 is accumulated. In this case, as the power source 4, a storage battery can be used or a capacitor can be used. The power source 4 may have a function of charging an electric vehicle by supplying the accumulated regenerative electric power. In this case, the power source 4 can be used as a quick charger. In addition, the power source 4 may be included in an electric power system of an electric power company and has a function of supplying electric power to power receiving equipment.

The control unit 5 outputs a control command to the internal combustion engine 2 and outputs a control signal to the diagnosis device 1 for the internal combustion engine.

The current information detection unit 6 acquires current information of the electric motor 3. As the current information detection unit 6, a clamp-type current sensor such as a current transformer (CT) type or a Rogowski type can be used. It is necessary that the current information acquired by the current information detection unit 6 from the electric motor 3 includes at least current information for two phases in a case the electric motor is a three-phase alternating-current synchronous motor. In a case where the current information detection unit 6 acquires the current information for the two phases, the current information acquisition unit 11 calculates current information for the third phases using Equation (1), as described later.

### [Diagnosis Device 1 for Internal Combustion Engine]

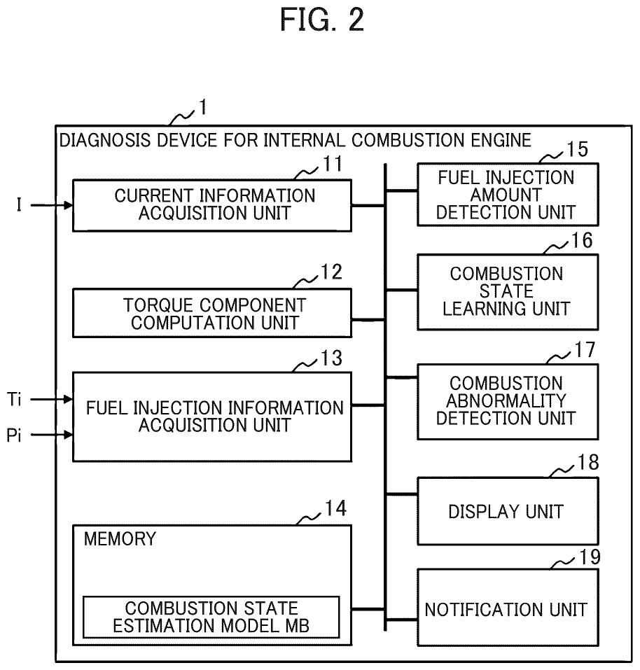

FIG. 2 is a functional block diagram of the diagnosis device for the internal combustion engine according to the present embodiment. As illustrated in FIG. 2, the diagnosis device 1 for the internal combustion engine includes a current information acquisition unit 11, a torque component computation unit 12, a fuel injection information acquisition unit 13, a memory 14, a fuel injection amount detection unit 15, a combustion state learning unit 16, a combustion abnormality detection unit 17, a display unit 18, and a notification unit 19. The diagnosis device 1 for the internal combustion engine is specifically a computer including hardware such as an arithmetic device such as a CPU, a main storage device such as a semiconductor memory, an auxiliary storage device such as a hard disk, and a communication device. The above-described functions are implemented by the arithmetic device executing a program loaded in the main storage device while referring to data recorded in the auxiliary storage device. However, in the following description, while such a known technique is appropriately omitted, details of the units are described.

### [Current Information Acquisition Unit 11]

The current information acquisition unit 11 acquires current information I from the current information detection unit 6. The acquisition of the current information I is performed at every sampling period determined based on at least the rotation speed of the motor and the resolution of the current. In this case, it is desirable that the current information I acquired from the current information detection unit 6 include current information for at least two phases of the three-phase (U phase, V phase, W phase) alternating-current motor. For example, in a case where the current information acquisition unit 11 acquires current information for two phases, the U phase and the V phase, from the current information detection unit 6, the current information acquisition unit 11 calculates current information for the W phase using Equation (1).

$$\begin{matrix}[ Equation 1 ] & \\ {I}_{u} + {I}_{v} + {I}_{w} = 0 & ( 1 )\end{matrix}$$

In Equation (1), Iu, Iv, and Iw indicate current information acquired from electric wires of the U phase, the V phase, and the W phase, respectively.

FIG. 3 is a diagram for explaining a method of breaking down the current information into combustion sections of the respective cylinders. An upper diagram in FIG. 3 illustrates data extracted from current information (current value) for one phase included in the current information acquired by the current information acquisition unit 11. In the upper diagram in FIG. 3, the vertical axis indicates the current value and the horizontal axis indicates time. The current information indicates the current information of the motor in which the number of pole pairs is 4 as an example, and two electrical angle periods (720 degrees) are a mechanical angle of 180 degrees. Therefore, in the upper diagram in FIG. 3, the mechanical angle advances by 180 degrees in a time period corresponding to the two electrical angle periods.

A lower diagram in FIG. 3 illustrates a history of a voltage of a cam sensor attached to a camshaft portion of the engine. In the lower diagram in FIG. 3, the vertical axis indicates the voltage of the cam sensor and the horizontal axis indicates a crank angle. The cam sensor is used as means for determining a cylinder in control of the engine. In this case, as the cam sensor, a sensor is exemplified, in which a voltage trigger is generated once at a crank angle of 180 degrees, which is a mechanical angle, and an additional voltage trigger is generated once immediately before the combustion section of the first cylinder in order to identify the first cylinder.

Normally, the synchronous motor does not slip unlike an induction motor, and the rotation speed of the engine and the rotation speed of the motor are synchronized. Therefore, the rise of the voltage of the cam sensor illustrated in the upper diagram of FIG. 3 is synchronized with the time of two electrical angle periods in the current information illustrated in the lower diagram of FIG. 3 (dotted lines in FIG. 3 indicate synchronization sections). Therefore, the current information can be broken down into the combustion sections of the respective cylinders by acquiring both the voltage of the cam sensor and a current value, as illustrated in FIG. 3.

Meanwhile, by using the characteristics of the current information of the synchronous motor, it is also possible to determine the mechanical angle from the number of pole pairs of the electric motor 3 and the electrical angle of the electric motor 3 and to break down the current information into the combustion sections of the respective cylinders without using a signal of the cam sensor.

### [Torque Component Computation Unit 12]

The torque component computation unit 12 calculates a q-axis current Iq from Equations (2) using current information for the three phases from the current information acquisition unit 11.

$$\begin{matrix}[ Equations 2 ] & \\ {I}_{α} = \sqrt{\frac{2}{3}} ( {I}_{u} - \frac{1}{2} {I}_{v} - \frac{1}{2} {I}_{w} ) & ( 2 )\end{matrix}$$

$${I}_{β} = \sqrt{\frac{2}{3}} ( \frac{\sqrt{3}}{2} {I}_{v} - \frac{\sqrt{3}}{2} {I}_{w} )$$

$${I}_{q} = - sin ( θ ) * {I}_{α} + cos ( θ ) * {I}_{β}$$

In Equations (2), 0 indicates the electrical angle of the current information. In addition, the q-axis current Iq is a component of a current that flows through the electric motor 3 and varies depending on torque received from the internal combustion engine 2. The q-axis current Iq is hereinafter referred to as a torque component Iq of the current.

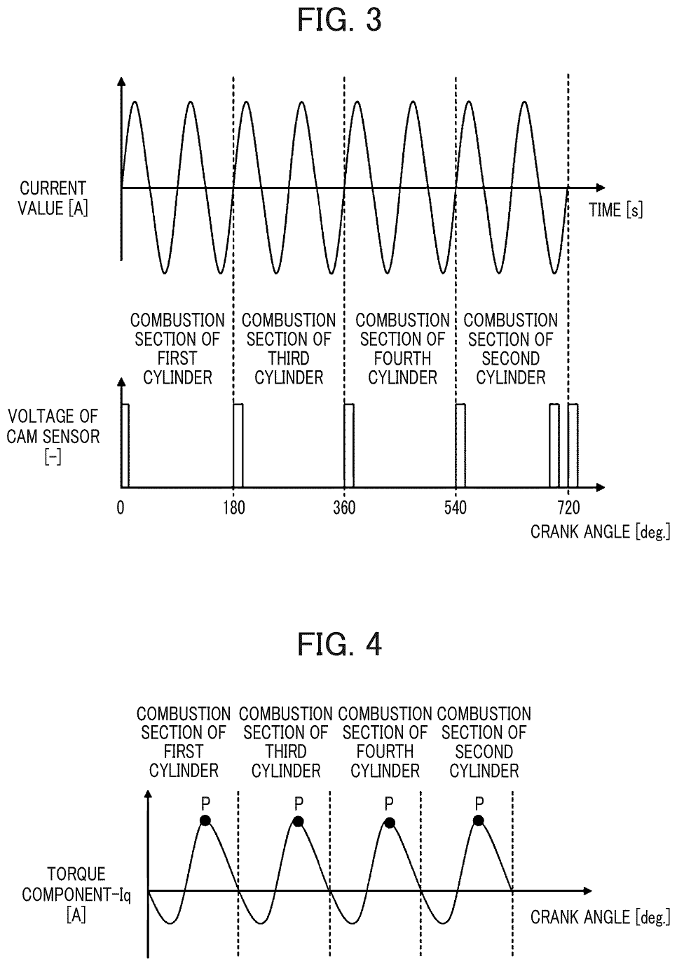

FIG. 4 is a diagram illustrating an example of a waveform of the torque component. In FIG. 4, the vertical axis indicates a torque component −Iq of the internal combustion engine, and the horizontal axis indicates the crank angle. In FIG. 4, for each of the explanation, the torque component Iq calculated based on Equations (2) is multiplied by −1 and the torque component −Iq of the internal combustion engine with its sign reversed is illustrated. This is because the torque component obtained from Equations (2) is a torque component detected on the electric motor 3 side and thus the torque component of the internal combustion engine 2 is based on the fact that the positive and negative sides are reversed. In the data illustrated in FIG. 4, the reason why the torque component −Iq of the internal combustion engine indicates a negative value is that it is necessary to push a piston up to a top dead center before combustion in each cylinder, and the reason why the torque component −Iq of the internal combustion engine indicates a positive value is that work is performed on the electric motor 3 due to combustion in each cylinder. As illustrated in FIG. 4, the torque component −Iq of the internal combustion engine has a torque peak P in each of the combustion sections of the respective cylinders.

### [Fuel Injection Information Acquisition Unit 13]

The fuel injection information acquisition unit 13 acquires, as fuel injection information, command values corresponding to a fuel injection pulse width Ti and fuel injection pressure Pi output from the control unit 5. The fuel injection pulse width Ti corresponds to a valve opening time per injection of an injection valve of a fuel injector.

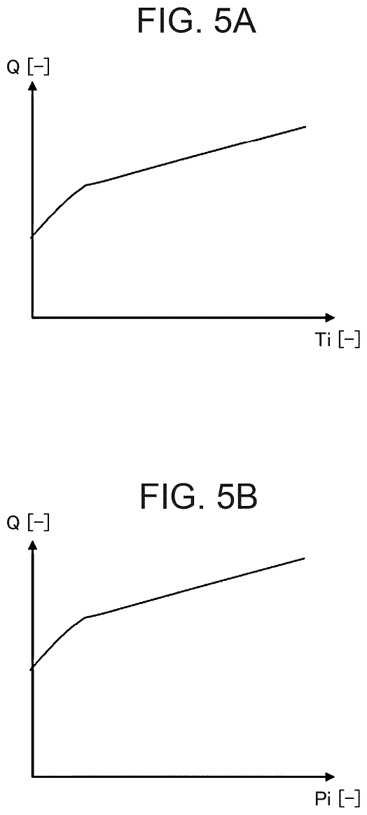

The fuel injection pressure Pi indicates a pressure value of fuel introduced into the fuel injector. FIG. 5 are diagrams for explaining a relationship between the fuel injection information and an amount of fuel injected. Specifically, FIG. 5 (a) illustrates a relationship between the fuel injection pulse width Ti (horizontal axis) and the amount Q of fuel injected (vertical axis), and FIG. 5 (b) illustrates a relationship between the fuel injection pressure Pi (horizontal axis) and the amount Q of fuel injected (vertical axis). As illustrated in FIG. 5, there are qualitatively positive correlations between the fuel injection pulse width Ti and the amount Q of fuel injected and between the fuel injection pressure Pi and the amount Q of fuel injected. The fuel injection pulse width and the fuel injection pressure acquired by the fuel injection information acquisition unit 13 are an example of the fuel injection information and are not limited thereto. A command value of an air-fuel ratio, the amount of air to be sucked, or the like that is to be used to determine the amount of fuel to be injected can also be used as the fuel injection information.

### [Fuel Injection Amount Detection Unit 15]

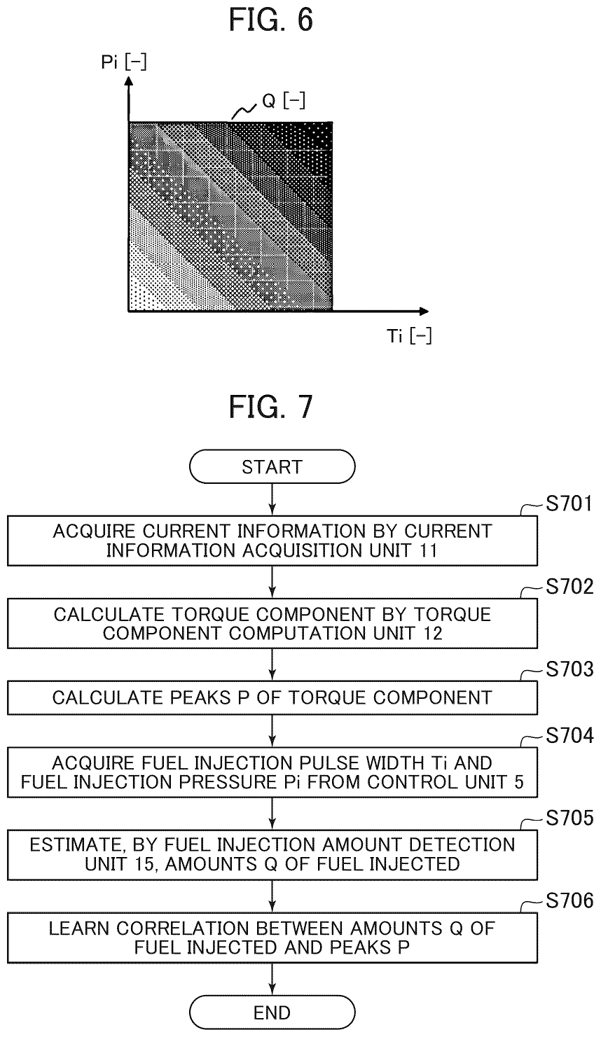

FIG. 6 is a diagram illustrating an example of a map of the amount Q of fuel injected. Specifically, FIG. 6 illustrates a map of the amount Q of fuel injected with respect to the fuel injection pulse width Ti (horizontal axis) and the fuel injection pressure Pi (vertical axis). FIG. 6 illustrates a case where the deeper color is, the larger the amount Q of fuel injected is. It is desirable that the fuel injection amount detection unit 15 has recorded therein the map of the amount Q of fuel injected in advance. Therefore, the fuel injection amount detection unit 15 can estimate the amount Q of fuel injected using the map of the amount Q of fuel injected in FIG. 6 by acquiring the fuel injection pulse width Ti and the fuel injection pressure Pi from the fuel injection information acquisition unit 13. In this case, each unit is dimensionless but may be dimensional.

### [Learning Process]

FIG. 7 is a flowchart of a learning process according to the first embodiment. The learning process in the diagnosis device 1 for the internal combustion engine will be described in detail with reference to the flowchart of FIG. 7. The learning process may be executed every time a certain period of time elapses, or may be performed in response to a command from an operator.

First, in step S701, the current information acquisition unit 11 acquires the current information I and proceeds to step S702. In step S702, the torque component computation unit 12 calculates the torque component Iq from the acquired current information and proceeds to step S703. In step S703, the combustion abnormality detection unit 17 acquires, as combustion characteristic amounts, torque peaks P in the respective combustion sections of the cylinders from the torque component Iq acquired in step S702. In step S704, the fuel injection information acquisition unit 13 acquires the fuel injection pulse width Ti and the fuel injection pressure Pi from the control unit 5 and proceeds to step S705. In step S705, the fuel injection amount detection unit 15 estimates amounts Q of fuel injected and proceeds to step S706. In step S706, the combustion state learning unit 16 learns, as a combustion state estimation model MB, a correlation between the amounts Q of fuel injected and the torque peaks P, determines an upper limit threshold H and a lower limit threshold L for the torque peaks P based on the learned combustion state estimate model MB, stores the combustion state estimation model MB, the upper limit threshold H, and the lower limit threshold L to the memory 14, and ends the procedure of the learning process.

The diagnosis device 1 for the internal combustion engine performs the learning process in both a steady states in which a change in the rotation speed of the internal combustion engine is small and a transient state in which a change in the rotation speed of the internal combustion engine is large. Thus, the diagnosis device 1 for the internal combustion engine can estimate the combustion state of the internal combustion engine and can detect abnormal combustion even in the steady state and even in the transient state.

### [Combustion State Learning Unit 16]

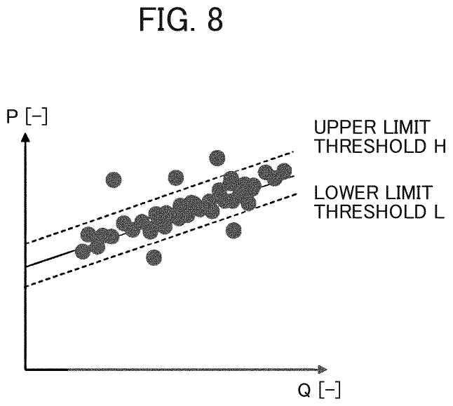

FIG. 8 is a diagram illustrating plotted torque peaks with respect to amounts of fuel injected according to the first embodiment.

In FIG. 8, the vertical axis indicates the torque peak P and the horizontal axis indicates the amount Q of fuel injected. The combustion state learning unit 16 sequentially acquires data including pairs of torque peaks P and amounts Q of fuel injected and learns a correlation between the torque peaks P and the amounts Q of fuel injected from the acquired data. The intensive research by the inventor has revealed that, in a case where the internal combustion engine 2 is operated while the rotation speed and torque fluctuate, the torque peaks P and the amounts Q of fuel injected indicate a linear correlation, although the torque peaks P and the amounts Q of fuel injected vary by certain values.

That is, the torque peaks P are related to combustion pressure in the cylinders. In a case where the amount of fuel introduced in the internal combustion engine 2 is large, the combustion pressure increases, and as a result, the torque peak P increases. That is, it is possible to estimate the combustion state of the internal combustion engine 2 by learning a value of the torque peak P associated with a condition for the amount of fuel injected.

In this case, learning the correlation between the torque peaks P and the amounts Q of fuel injected refers to learning a correlation function of the torque peaks P associated with the amounts Q of fuel injected, for example, a distribution of the torque peaks P with respect to the amounts Q of fuel injected as illustrated in FIG. 8 as the combustion state estimation model MB. In addition, in a case where learned contents are a distribution of the torque peaks P, the combustion state learning unit 16 calculates a standard deviation o of the torque peaks P in the distribution of the torque peaks P, and sets the upper limit threshold H for the torque peaks P to +30 and the lower limit threshold L to −3σ, thereby determining the upper limit threshold H and the lower limit threshold L. Then, the combustion state learning unit 16 stores the combustion state estimation model MB, the upper limit threshold H, and the lower limit threshold L to the memory 14. The combustion state learning unit 16 can integrate information of the upper limit threshold H and the lower limit threshold L with the distribution of the learned torque peaks P, and store, as the combustion state estimation model MB, the distribution of the torque peaks P that has been integrated with the information of the upper limit threshold H and the lower limit threshold L to the memory 14. In addition, the upper limit threshold H and the lower limit threshold are set to +3σ and −3σ, respectively, but are not limited thereto. The upper limit threshold H and the lower limit threshold can be changed according to required accuracy of detecting abnormal combustion or the like.

The combustion state learning unit 16 distinguishes and learns the torque peaks P in the combustion sections of the cylinders as illustrated in FIG. 4. That is, the combustion state learning unit 16 acquires the distribution of the torque peaks P in the respective combustion sections and learns the correlation between the torque peaks P and the amounts Q of fuel injected. In this case, the plot diagram illustrated in FIG. 8 is acquired for each of the combustion sections. Then, the combustion state learning unit 16 determines the upper limit threshold H and the lower limit threshold L for the torque peaks P for each of the combustion sections. Therefore, it is possible to detect abnormal combustion for each of the cylinders. In addition, the combustion state learning unit 16 can learn the torque peaks P in the combustion sections of the cylinders illustrated in FIG. 4 without distinguishing the torque peaks P. That is, the combustion state learning unit 16 acquires the distribution of the torque peaks P from the torque peaks P in the respective combustion sections and learns the correlation between the torque peaks P and the amounts Q of fuel injected. In this case, the plot diagram illustrated in FIG. 8 includes the torque peaks P in the respective combustion sections. In a case where the torque peaks P in the combustion sections are learned without being distinguished, the distribution of the torque peaks P is acquired using the torque peaks P in the plurality of combustion sections, and thus the number of samples of data increases and the accuracy of the distribution is improved.

### [Abnormality Detection Process]

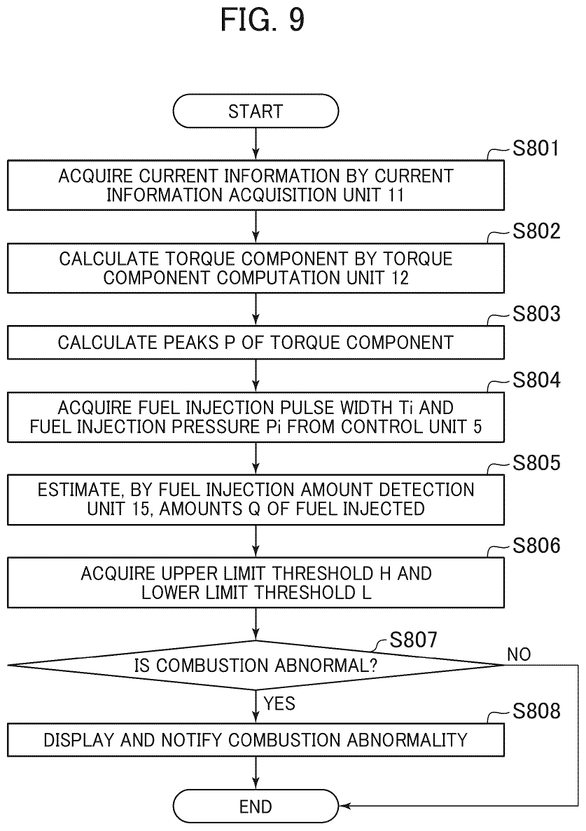

FIG. 9 is a flowchart of an abnormality detection process according to the first embodiment. The abnormality detection process in the diagnosis device 1 for the internal combustion engine will be described with reference to the flowchart of FIG. 9. The abnormality detection process may be performed every time a certain period of time elapses, or may be performed according to a command from the operator.

In addition, it is assumed that the diagnosis device 1 for the internal combustion engine acquires current information for a predetermined number of revolutions of the internal combustion engine, and performs the abnormality detection process using the acquired current information.

First, in step S801, the current information acquisition unit 11 acquires the current information I and proceeds to step S802. In step S802, the torque component computation unit 12 calculates the torque component Iq from the acquired current information and proceeds to step S803. In step S803, the combustion abnormality detection unit 17 acquires, as combustion characteristic amounts, the torque peaks P in the respective combustion sections of the cylinders from the torque component Iq acquired in step S802. In step S804, the fuel injection information acquisition unit 13 acquires the fuel injection pulse width Ti and the fuel injection pressure Pi from the control unit 5 and proceeds to step S805. In step S805, the fuel injection amount detection unit 15 estimates the amounts Q of fuel injected and proceeds to step S806. In step S806, the combustion abnormality detection unit 17 refers to the upper limit threshold H and the lower limit threshold L for the combustion characteristic amounts (torque peaks P) stored in the memory 14, and acquires the upper limit threshold H and the lower limit threshold L for the combustion characteristic amounts (torque peaks P) with respect to the amounts Q of fuel injected that have been estimated by the fuel injection amount detection unit 15. In a case where the upper limit thresholds H and the lower limit thresholds L are stored in the memory 14 for each of the combustion sections, the combustion abnormality detection unit 17 acquires the upper limit thresholds H and the lower limit thresholds L for the combustion sections in which the torque peaks P have been acquired. In step S807, it is checked whether each of the torque peaks P calculated in step S803 exceeds the upper limit threshold H acquired in step S806 or falls below the lower limit threshold L acquired in step S806. In a case where the torque peak P exceeds the upper limit threshold H, it is determined that abnormal combustion that is called knocking or pre-ignition has occurred. Meanwhile, in a case where the torque peak P falls below the lower limit threshold L, it is determined that a misfire has occurred. In a case where torque peak P exceeds the upper limit threshold H or falls below the lower limit threshold L, that is, a threshold deviation occurs, the process proceeds to S808. In step S808, the abnormal combustion determined in S807 is displayed and notified. In this case, the display of the abnormal combustion is performed by the display unit 18, and the notification of the abnormal combustion is performed by the notification unit 19. In a case where the threshold deviation does not occur in step S807, the abnormal detection process is ended. The display unit 18 and the notification unit 19 may perform the display and notification of the combustion state of the internal combustion engine 2 even in a case where the combustion state of the internal combustion engine 2 is not abnormal. In a case where the combustion state of the internal combustion engine 2 is not abnormal, for example, the display and notification of normal combustion or the like are conceivable. In addition, the diagnosis device 1 for the internal combustion engine may include only either the display unit 18 or the notification unit 19.

### [Behaviors During Actual Operation]

The combustion abnormality detection unit 17 uses the combustion state estimation model MB stored in the memory 14 by the combustion state learning unit 16 to estimate the combustion state from the current information I acquired by the current information acquisition unit 11.

In the present embodiment, the torque peaks P of the torque component Iq are used as the combustion characteristic amounts, but the combustion characteristic amounts are not limited thereto. For example, instead of the torque peaks P of the torque component Iq, effective values of the torque component Iq can be used as the combustion characteristic amounts.

As described above in detail, according to the present embodiment, for example, in a case where a knocking sensor or the in-cylinder pressure sensor of the internal combustion engine is not present or fails, an abnormal combustion state can be efficiently notified to the operator by the combustion state estimation model MB that estimates the combustion state from the current information.

### Second Embodiment

Next, a diagnosis device 1 for an internal combustion engine according to a second embodiment of the present invention will be described. Description of common features to the first embodiment will be omitted.

### [Diagnosis Device 1 for Internal Combustion Engine]

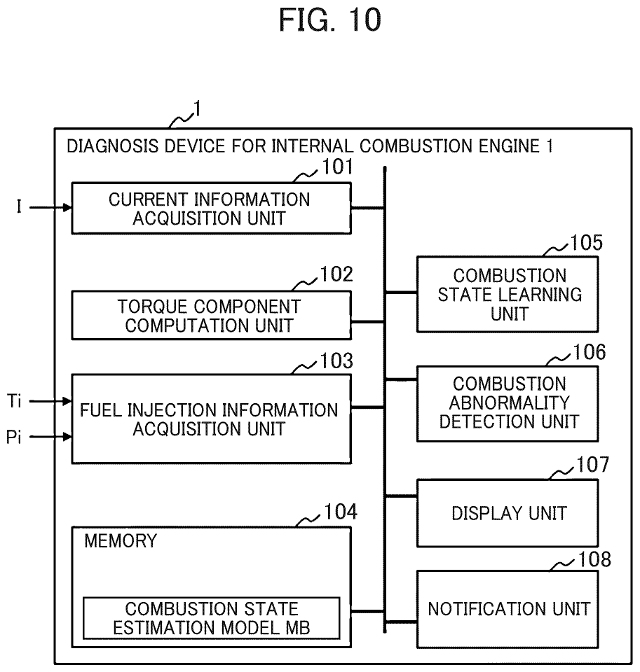

FIG. 10 is a functional block diagram of the diagnosis device 1 for the internal combustion engine according to the second embodiment. As illustrated in this drawing, the diagnosis device 1 for the internal combustion engine includes a current information acquisition unit 101, a torque component computation unit 102, a fuel injection information acquisition unit 103, a memory 104, a combustion state learning unit 105, a combustion abnormality detection unit 106, a display unit 107, and a notification unit 108. The configuration of the diagnosis device 1 for the internal combustion engine according to the second embodiment is the same as or similar to a configuration obtained by removing the fuel injection amount detection unit 15 from the diagnosis device 1 for the internal combustion engine according to the first embodiment.

### [Learning Process]

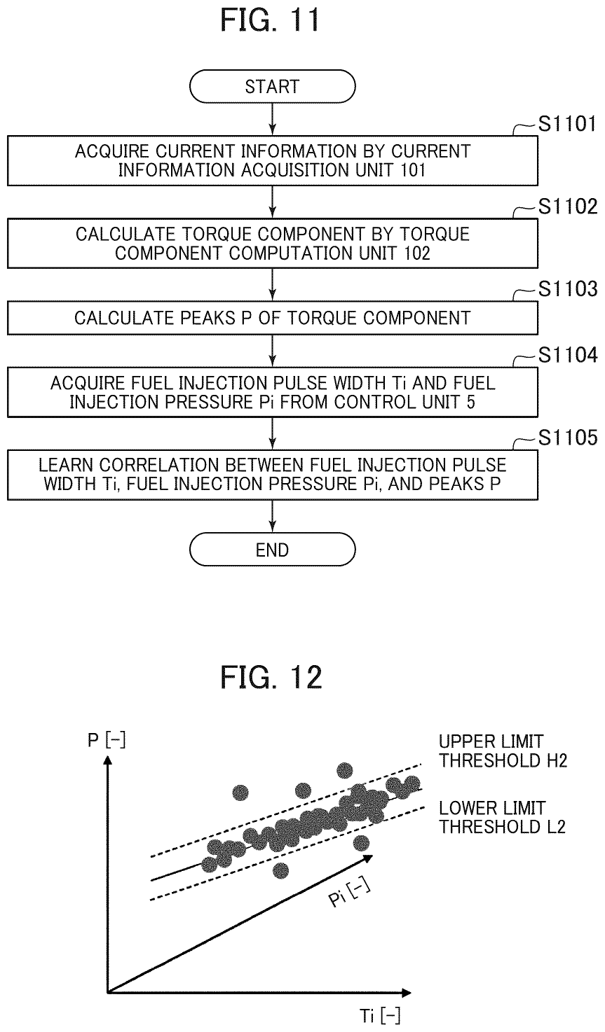

FIG. 11 is a flowchart of a learning process according to the second embodiment. The learning process in the diagnosis device 1 for the internal combustion engine will be described in detail with reference to the flowchart of FIG. 11. The learning process may be executed every time a certain period of time elapses, or may be performed in response to a command from an operator.

Steps S1101 to S1104 are the same as or similar to steps S701 to S704 in the first embodiment. In S1105, the combustion state learning unit 105 learns, as a combustion state estimation model MB, a correlation between the fuel injection pulse width Ti, the fuel injection pressure Pi, and the torque peaks P, determines an upper limit threshold H and a lower limit threshold L for the torque peaks P based on the learned combustion state estimation model MB, stores the combustion state estimation model MB, the upper limit threshold H, and the lower limit threshold L to the memory 104, and ends the procedure of the learning.

### [Combustion State Learning Unit 105]

FIG. 12 is a diagram illustrating plotted torque peaks with respect to the fuel injection pulse width and the fuel injection pressure according to the second embodiment. In FIG. 12, the axes indicate the torque peak P, the fuel injection pulse width Ti, and the fuel injection pressure Pi. The combustion state learning unit 105 sequentially acquires data including sets of the torque peaks P, the fuel injection pulse width Ti, and the fuel injection pressure Pi, and learns a correlation between the torque peaks P, the fuel injection pulse width Ti, and the fuel injection pressure Pi from the acquired data. The intensive research by the inventor has revealed that, in a case where the internal combustion engine 2 is operated while the rotation speed and torque fluctuate, the torque peak P, the fuel injection pulse width Ti, and the fuel injection pressure Pi indicate a linear correlation, although the torque peak P and the amount Q of fuel injected vary by certain values. That is, as described above, the torque peak P is proportional to the amount Q of fuel injected, and the amount Q of fuel injected has positive correlations with each of the fuel injection pulse width Ti and the fuel injection pressure Pi, as illustrated in FIG. 5. Therefore, when at least one of the fuel injection pulse width Ti and the fuel injection pressure Pi is increased, the amount of fuel introduced in the internal combustion engine 2 increases, and as a result, the torque peak P increases. From this, it is possible to estimate the combustion state of the internal combustion engine 2 by learning the value of the torque peak P associated with the fuel injection pulse width Ti and the fuel injection pressure Pi.

In this case, learning the correlation between the fuel injection pulse width Ti, the fuel injection pressure Pi, and the torque peak P refers to learning, as the combustion state estimation model MB, a correlation function of the torque peak P associated with the fuel injection pulse width Ti and the fuel injection pressure Pi, for example, a distribution of the torque peaks P with respect to the fuel injection pulse width Ti and the fuel injection pressure Pi as illustrated in FIG. 12. In addition, in a case where learned contents are a distribution of the torque peaks P, the combustion state learning unit 105 calculates a standard deviation o of the torque peaks P in the distribution of the torque peaks P, and determines the upper limit threshold H and the lower limit threshold L by setting the upper limit threshold H for the torque peaks P to +30 and the lower limit threshold L for the torque peaks P to −30. Then, the combustion state learning unit 16 stores the combustion state estimation model MB, the upper limit threshold H, and the lower limit threshold L to the memory 104.

The fuel injection pulse width and the fuel injection pressure acquired by the fuel injection information acquisition unit 13 are an example of the fuel injection information and are not limited thereto. A command value of an air-fuel ratio, the amount of air to be sucked, or the like that is to be used to determine the amount of fuel to be injected can also be used as the fuel injection information. In addition, in a case where the control unit 5 calculates command values of an amount of fuel to be injected and a fuel flow rate, the fuel injection information acquisition unit 13 can acquire, as the fuel injection information, the command values of the amount of fuel to be injected and the fuel flow rate from the control unit 5.

### [Abnormality Detection Process]

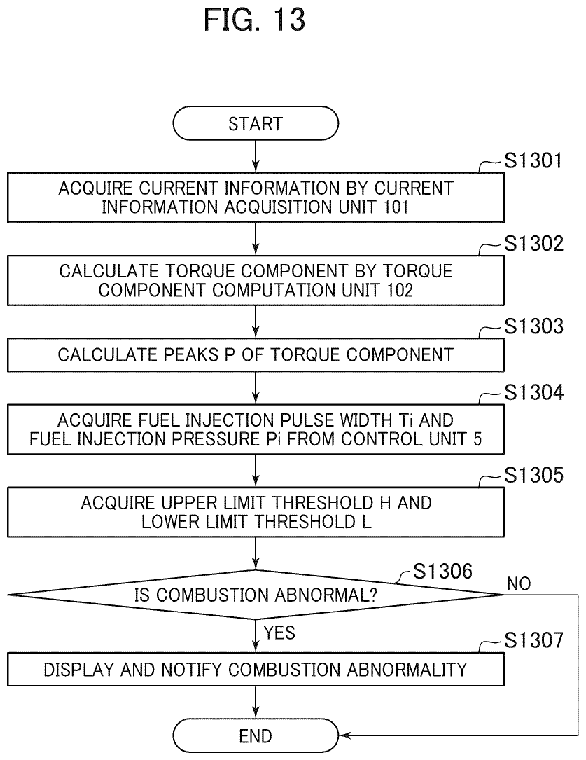

FIG. 13 is a flowchart of an abnormality detection process according to the second embodiment. The abnormality detection process in the diagnosis device 1 for the internal combustion engine will be described with reference to the flowchart of FIG. 13. The abnormality detection process may be performed every time a certain period of time elapses, or may be performed according to a command from the operator.

Steps S1301 to S1304 are the same as or similar to steps S801 to S804 in the first embodiment. In step S1305, the combustion abnormality detection unit 106 refers to the upper limit threshold H and the lower limit threshold L for the combustion characteristic amounts (torque peaks P) stored in the memory 104, and acquires the upper limit threshold H and the lower limit threshold L for the combustion characteristic amounts (torque peaks P) with respect to the fuel injection pulse width Ti and the fuel injection pressure Pi. Steps S1306 and S1307 are the same as or similar to steps S807 and S808 in the first embodiment.

### [Behaviors During Actual Operation]

The combustion abnormality detection unit 106 uses the combustion state estimation model MB stored in the memory 104 by the combustion state learning unit 105 to estimate the combustion state from the current information I acquired by the current information acquisition unit 101.

As described above in detail, according to the present embodiment, for example, in a case where a knocking sensor or the in-cylinder pressure sensor of the internal combustion engine is not present or fails, an abnormal combustion state can be efficiently notified to the operator by the combustion state estimation model MB that estimates the combustion state from the current information.

In addition, the diagnosis device 1 for the internal combustion engine according to the present embodiment does not calculate an amount Q of fuel injected from the fuel injection pulse width Ti and the fuel injection pressure Pi and thus can reduce the calculation load.

### LIST OF REFERENCE SIGNS

1: diagnosis device for internal combustion engine
11, 101: current information acquisition unit
12, 102: torque component computation unit
13, 103: fuel injection information acquisition unit
14, 104: memory
15: fuel injection amount detection unit
16, 105: combustion state learning unit
17, 106: combustion abnormality detection unit
18, 107: display unit
19, 108: notification unit
2: internal combustion engine
3: electric motor
4: power source
5: control unit
6: current information detection unit

1. A diagnosis device for an internal combustion engine that diagnoses the internal combustion engine that causes an electric motor to generate electric power, the diagnosis device comprising:
a current information acquisition unit that acquires current information from the electric motor;
a fuel injection information acquisition unit that acquires fuel injection information from a control unit that controls the internal combustion engine; and
a combustion abnormality detection unit that estimates a combustion state of the internal combustion engine based on the current information and the fuel injection information.

2. The diagnosis device for the internal combustion engine according to claim 1, the diagnosis device further comprising:
a torque component computation unit that calculates, based on the current information, a torque component that is indicated in the current information and varies according to torque received by the electric motor from the internal combustion engine,
wherein the combustion abnormality detection unit estimates the combustion state of the internal combustion engine based on the torque component and the fuel injection information.

3. The diagnosis device for the internal combustion engine according to claim 2,
wherein the fuel injection information includes a fuel injection pulse width and fuel injection pressure.

4. The diagnosis device for the internal combustion engine according to claim 3, the diagnosis device further comprising:
a fuel injection amount detection unit that uses the fuel injection pulse width and the fuel injection pressure to estimate an amount of fuel injected to be introduced in the internal combustion engine,
wherein the combustion abnormality detection unit estimates a combustion state of each of cylinders of the internal combustion engine based on the torque component and the amount of fuel injected.

5. The diagnosis device for the internal combustion engine according to claim 4,
wherein the combustion abnormality detection unit calculates a combustion characteristic amount from the torque component, and determines that the combustion state of the internal combustion engine is abnormal when the combustion characteristic amount exceeds an upper limit threshold for the combustion characteristic amount defined in advance for each of amounts of fuel injected or falls below a lower limit threshold for the combustion characteristic amount defined in advance for each of amounts of fuel injected.

6. The diagnosis device for the internal combustion engine according to claim 5, the diagnosis device further comprising:
a combustion state learning unit that acquires a plurality of data pieces including pairs of the combustion characteristic amounts calculated by the combustion abnormality detection units and the amounts of fuel injected that have been estimated by the fuel injection amount detection unit, calculates a standard deviation of the combustion characteristic amounts from the data pieces, and determines, based on the calculated standard deviation, the upper limit thresholds and the lower limit thresholds for the combustion characteristic amounts for each of the amounts of fuel injected,
wherein the combustion abnormality detection unit acquires the upper limit thresholds and the lower limit thresholds determined by the combustion state learning unit.

7. The diagnosis device for the internal combustion engine according to claim 2,
wherein the combustion abnormality detection unit calculates a combustion characteristic amount from the torque component, and determines that the combustion state of the internal combustion state is abnormal when the combustion characteristic amount exceeds an upper limit threshold for the combustion characteristic amount defined for each piece of the fuel injection information or falls below a lower limit threshold for the combustion characteristic amount defined for each piece of the fuel injection information.

8. The diagnosis device for the internal combustion engine according to claim 7, the diagnosis device further comprising:
a combustion state learning unit that acquires a plurality of data pieces including pairs of the combustion characteristic amounts calculated by the combustion abnormality detection unit and the fuel injection information acquired by the fuel injection information acquisition unit, calculates a standard deviation of the combustion characteristic amounts from the data pieces, and determines, based on the calculated standard deviation, the upper limit thresholds and the lower limit thresholds for the combustion characteristic amounts for each piece of the fuel injection information,
wherein the combustion abnormality detection unit acquires the upper limit thresholds and the lower limit thresholds determined by the combustion state learning unit.

9. The diagnosis device for the internal combustion engine according to claim 5,
wherein the combustion characteristic amount is a torque peak of the torque component.

10. The diagnosis device for the internal combustion engine according to claim 2,
wherein the current information acquisition unit breaks down the current information into combustion sections of cylinders of the internal combustion engine,
the torque component computation unit calculates the torque component based on the current information broken down into the combustion sections of the cylinders, and
the combustion abnormality detection unit estimates a combustion state of each of the cylinders of the internal combustion engine based on the torque component and the fuel injection information.

11. The diagnosis device for the internal combustion engine according to claim 1, the diagnosis device further comprising:
at least one of a display unit that displays the combustion state of the internal combustion engine, and a notification unit that notifies the combustion state of the internal combustion engine.

12. A diagnosis method for an internal combustion engine that diagnoses the internal combustion engine that causes an electric motor to generate electric power, the method comprising:
a current information acquisition step of acquiring current information from the electric motor;
a fuel injection information acquisition step of acquiring fuel injection information from a control unit that controls the internal combustion engine; and
a combustion abnormality detection step of estimating a combustion state of the internal combustion engine based on the current information and the fuel injection information.
